(19) United States
(12) Patent Application Publication
(10) Pub. No.: US 2005/0128029 A1
(43) Pub. Date: Jun. 16, 2005

(54) Ferroelectric epitaxial thin film for microwave tunable device and microwave tunable device using the same

(76) Inventors: Su Jae Lee, Daejeon-Shi (KR); Seung Eon Moon, Daejeon-Shi (KR); Han Cheol Ryu, Seoul (KR); Min Hwan Kwak, Jinju-Shi (KR)

Correspondence Address: JACOBSON HOLMAN PLLC, 400 SEVENTH STREET N.W., SUITE 600, WASHINGTON, DC, 20004, US

(21) Appl. No.: 10/817,852

(22) Filed: Apr. 6, 2004

(30) Foreign Application Priority Data
Dec. 10, 2003 (KR) 2003-89374

(51) Int. Cl. H01P 1/18

(52) U.S. Cl. 333/161

(57) ABSTRACT

Provided are a ferroelectric epitaxial thin film for a microwave tunable device including a ferroelectric BaTiO₃ seed layer and an epitaxial (Ba₁₋ₓSrₓ)TiO₃ thin film, and a microwave tunable device using the same, whereby it is possible to improve the microwave response property of the microwave tunable device, and to enhance the quality of the wireless communication with ultra high speed, low electric power, low cost, and high sensitivity, by using the device of the present invention as an active antenna system, a satellite communication system, or a wireless sensor system,

[symbol]

### BACKGROUND

1. Field of the Invention

The present invention relates to a ferroelectric epitaxial thin film for a microwave tunable device and a microwave tunable device using the same and, more particularly, to a ferroelectric epitaxial thin film having a large tunability of dielectric permittivity and a low dielectric loss, and a ferroelectric microwave tunable device capable of realizing ultra high speed, low electric power, and low cost, and having an excellent microwave property.

2. Discussion of Related Art

Recently, fresh wireless services, such as an international mobile telecommunication (IMT)-2000, a fourth generation mobile communication, a wireless internet, an ubiquitous network system, and etc., have been realized visibly. Whereby, developing a core new material/parts for a wireless mobile/satellite communication, and a sensor system with ultra high speed, low electric power, and low cost that can supply various services in many frequency bands, has been considered as an important issue. Therefore, it is fully required a development of a technology for a ferroelectric microwave tunable material and device that can complement demerits of devices implanted by a conventional semiconductor, a micro electro mechanical systems (MEMS), a magnetic material, and a photonics material, and realize an excellent microwave property.

The microwave tunable device using a ferroelectric thin film enables ultra high speed, low electric power, small size, light weight, low cost, large frequency/phase tunable property, broadband, and system on a chip (SoC). However, there have been several problems in the development of the microwave tunable device using the ferroelectric thin film, such as microwave loss, frequency/phase tunability, large operation voltage, and so on.

For improving the characteristics of the microwave tunable device as mentioned above, many studies for developing a ferroelectric epitaxial thin film and material using the same, which have an excellent microwave dielectric property, have been tried. In other words, it has been required a ferroelectric epitaxial thin film having a large tunability of dielectric permittivity and a low dielectric loss according to an external applied voltage, in order to implant the microwave tunable device having excellent characteristics.

Meanwhile, (Ba₁₋ₓSrₓ)TiO₃ (hereinafter, referred as to BST) out of many ferroelectric materials has been known as an influential material for implanting a ferroelectric microwave tunable device since it has a large tunability of dielectric permittivity and a low dielectric loss. In addition, many trials for enhancing the device properties have been made by improving dielectric properties such as the tunability of dielectric permittivity, dielectric loss, or the like, in the BST thin film.

However, there has been a limitation to obtain an epitaxial BST thin film having dielectric properties comparable to that of a BST single crystal, although a number of attempts for doping, high temperature in the growth, compensation for defect of Ba/Sr ratio, thickness dependence, and etc. have been made to obtain the BST thin film with a large tunability of dielectric permittivity and a low dielectric loss.

Especially, it was difficult to implant the ferroelectric microwave tunable device having superior characteristics in the case of the BST thin film grown on an oxide single crystal substrate, for the following reasons: an epitaxial thin film growth is not easy at a low temperature since there is a large lattice mismatching between the substrate and the BST thin film; it is difficult to obtain the BST thin film with a large tunability of dielectric permittivity and a low dielectric loss due to a large stain/stress effect inside the thin film; and it is not easy to implant the ferroelectric microwave tunable device having excellent characteristics since propagation loss of microwave signal increases.

### SUMMARY OF THE INVENTION

The present invention is contrived to solve the problems, and directed to a dielectric thin film for a microwave tunable device having improved dielectric properties.

According to the present invention, there is provided a ferroelectric microwave tunable device with excellent characteristics, by using a ferroelectrics having improved dielectric properties of a large tunability of dielectric permittivity and a low dielectric loss. In addition, it is possible to implant a voltage-controlled ferroelectric microwave tunable device having superior microwave characteristics, and capable of realizing ultra high speed, low electric power, and low cost.

One aspect of the present invention is to provide a ferroelectric epitaxial thin film for a microwave tunable device, comprising: a ferroelectric BaTiO₃ seed layer formed on a substrate with a predetermined thickness; and an epitaxial (Ba₁₋ₓSrₓ)TiO₃ (hereinafter, referred as to BST) film formed on the BaTiO₃ seed layer.

Here, the substrate is a magnesium oxide (MgO) single crystal substrate, and the epitaxial BST film has a composition of (Ba₁₋ₓSrₓ)TiO₃, where x is in the range of 0.1 to 0.9.

In a preferred embodiment of the present invention, the BaTiO₃ seed layer and/or the (Ba₁₋ₓSrₓ)TiO₃ film is an epitaxial thin film grown by means of pulse laser ablation, radio frequency (RF) magnetron sputtering, chemical vapor deposition, or atomic layer deposition method. Here, the BaTiO₃ seed layer has a thickness in the range of several Å to hundreds of Å, and the BST film has a thickness in the range of 0.1 μm to 1 μm.

Meanwhile, the microwave tunable device is a voltage-controlled tunable capacitor, a tunable resonator, a tunable filter, a phase shifter, a voltage-controlled tunable oscillator, a duplexer, or a divider.

Another aspect of the present invention is to provide a microwave tunable device, comprising: a substrate; a ferroelectric epitaxial thin film for the microwave tunable device formed on the substrate, according to the present invention; and at least one of electrodes formed on the ferroelectric epitaxial thin film.

Here, the microwave tunable device is a frequency or a phase tunable device, and it may be a voltage-controlled tunable capacitor, a phase shifter such as a coplanar waveguide phase shifter, a loaded line type phase shifter, etc., a tunable resonator, a tunable filter, a phase shifter, a voltage-controlled tunable oscillator, a duplexer, or a divider.

In a preferred embodiment of the present invention, the electrodes are composed of a multi-layer metallic film including a single metal layer or an adhesion layer, and the multi-layer metallic film is Au/Cr, Au/Ti, Ag/Cr, or Ag/Ti.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1A is a cross sectional view of a ferroelectric epitaxial thin film for a microwave tunable device, and FIG. 1B is a view for a crystal structure thereof, according to the present invention;

FIG. 2 is a view for showing a x-ray diffraction pattern at θ-2θ of a ferroelectric epitaxial thin film grown by a preferred embodiment of the present invention;

FIG. 3 is a perspective view of a voltage-controlled tunable capacitor that is one of the ferroelectric microwave tunable devices according to the present invention;

FIGS. 4A and 4B are graphs showing variations of electric capacitance and dielectric loss depending on a variation of a voltage applied to the voltage-controlled tunable capacitor of FIG. 3;

FIG. 5 is a perspective view of a coplanar waveguide (CPW) phase shifter that is one of the microwave tunable devices according to the present invention;

FIGS. 6A and 6B are graphs showing differential phase shift property depending on a frequency and an applied direct current (DC) bias voltage of the coplanar waveguide (CPW) phase shifter of FIG. 5;

FIG. 7 is a perspective view of a loaded line type ferroelectric phase shifter that is one of the microwave tunable devices according to the present invention; and

FIG. 8 is a graph showing differential phase shift depending on an applied DC bias voltage of the loaded line type phase shifter of FIG. 7.

### DETAILED DESCRIPTION OF PREFERRED EMBODIMENTS

Hereinafter, preferred embodiments of the present invention will be described in detail with reference to the accompanying drawings. The embodiments of the present invention are intended to more completely explain the present invention to those skilled in the art.

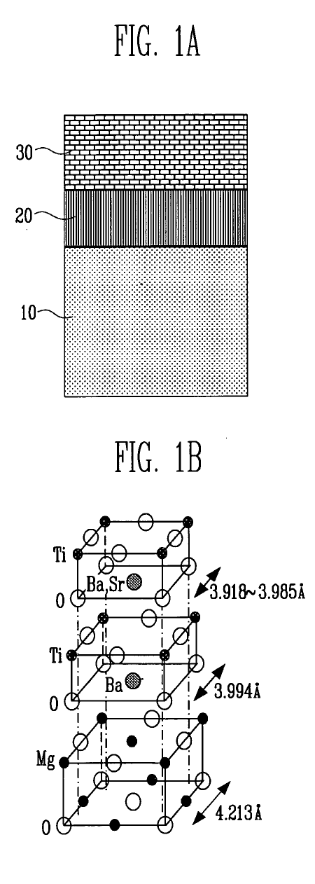

FIG. 1A shows a cross sectional view of a ferroelectric epitaxial thin film for a microwave tunable device and FIG. 1B is a crystal structure thereof, according to the present invention. The ferroelectric epitaxial thin film for the microwave tunable device comprises a BaTiO₃ (hereinafter, referred as to BT) seed layer 20 formed on a substrate 10 with a predetermined thickness, and an epitaxial BST film 30 formed thereon.

One of the characteristics in the present invention is that dielectric properties of the BST thin film 30 could be enhanced by lowering the lattice mismatching between the substrate 10 and the BST thin film 30, which would be a main cause of deteriorating the dielectric properties of the BST thin film 30 grown on the substrate 10, and decreasing the strain/stress effect caused by the lattice mismatching inside the thin film. For this, there is provided a specific method that crystalinity of the BST thin film 30 and dielectric properties can be enhanced, at the same time, by forming the thin ferroelectric BT seed layer 20, in which a lattice mismatching with the substrate 10 is small, and growing the BST thin film 30 thereon.

As for the substrate 10, a magnesium oxide MgO(001) single crystal substrate for the microwave device may be employed, and the MgO(001) substrate has a cubic NaCl structure. The MgO lattice constant of the substrate 10 is approximately 4.213 Å, and the lattice constant of the BT seed layer 20 is in the middle between those of the substrate 10 and the BST thin film 30. A lattice constant of a-axis orientation is 3.994 Å and a lattice mismatching degree with the MgO substrate 10 is 5.2%, so that an epitaxial growth would be possible.

Meanwhile, the thickness of the BT seed layer 20 is, preferably, in the range of several Å to hundreds of Å. If the thickness is hundreds of Å or more, the microwave property of the device may be deteriorated due to the effect of the dielectric property in the seed layer. On the other hand, if the thickness is several Å or less, the epitaxial BST thin film growth may be difficult since the seed layer could not perform its role.

The BST thin film 30 is formed on the BT seed layer 20. Preferably, the BST thin film has a thickness in the range of 0.1 to 1 μm and, in the case of the BST having a composition of Ba₁₋ₓSrₓTiO₃, x is in the range of 0.1 to 0.9. On the other hand, the lattice constant is in the range of 3.918 to 3.985 Å, depending on x value.

Method of growing the BT seed layer 20 and the BST thin film 30 on the MgO(001) single crystal substrate are not confined specifically, and various methods can be applied. For example, there may be pulsed laser ablation, RF magnetron sputtering deposition, chemical vapor deposition (CVD), atomic layer deposition (ALD), and etc.

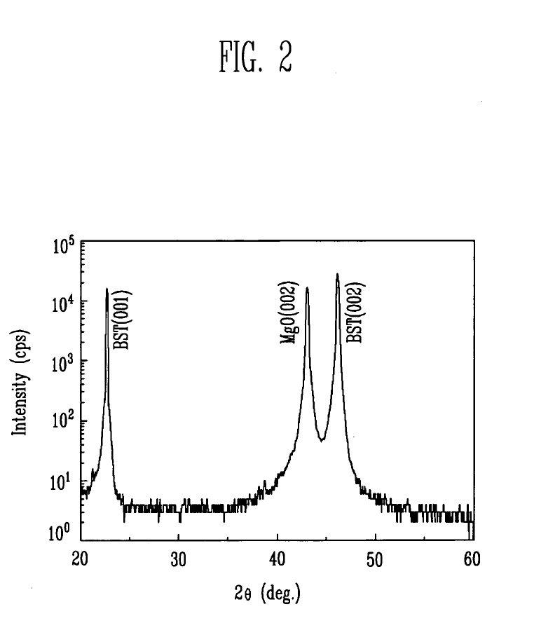

FIG. 2 is a view for showing a x-ray diffraction pattern at θ-2θ of a ferroelectric epitaxial thin film, which is grown after a seed layer is formed on the MgO(001) single crystal substrate in BT(001) direction by means of pulsed laser ablation method, in accordance with the present invention. The BST thin film is formed under the conditions of 750° C. in temperature and 200 mTorr in oxygen pressure. Referring to FIG. 2, it is noted that there is a x-ray diffraction peak only in (001) direction and an epitaxial thin film is formed in a BST(001) direction.

Meanwhile, it has been required a ferroelectric epitaxial thin film having a large tunability of dielectric permittivity and a low dielectric loss, in order to implant a ferroelectric microwave tunable device having an excellent microwave property.

Accordingly, examples that the ferroelectric epitaxial thin film for the microwave tunable device is applied to the ferroelectric microwave tunable device will be explained with reference to attached drawings. As for microwave tunable devices of the present invention, there are voltage-controlled tunable capacitor, phase shifters such as coplanar waveguide phase shifter, loaded line type phase shifter, and etc., tunable resonator, tunable filter, phase shifter, voltage-controlled tunable oscillator, duplexer, or divider. Of these applications, a voltage-controlled tunable capacitor, a coplanar waveguide phase shifter, and a loaded line type phase shifter, in which electrode materials are implanted on a BST(001)/BT(001)/MgO(001) multi-layer epitaxial thin film in accordance with the device property, will be described as an example of the present invention.

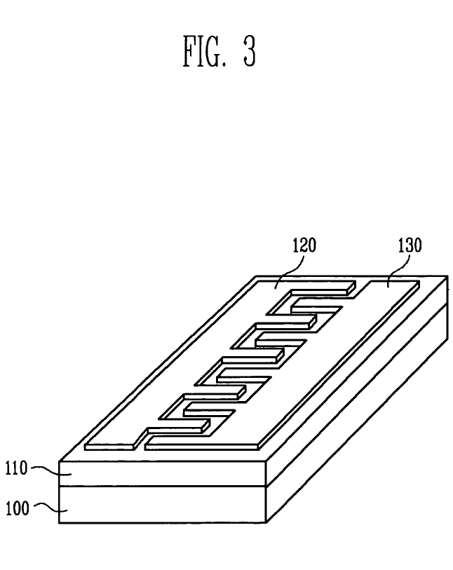

FIG. 3 is a perspective view of a voltage-controlled tunable capacitor that is one of the ferroelectric microwave tunable devices according to the present invention. The voltage-controlled tunable capacitor of the present invention comprises a BST/BT thin film 110 on a substrate 100 and metallic electrodes 120 and 130 formed thereon, and it may be applicable to a tunable filter, a tunable capacitor, a resonator, a phase shifter circuit, and so on.

The voltage-controlled tunable capacitor can be fabricated readily by means of a common lithography. For example, a seed layer of a BT(001) direction is formed on a magnesium oxide (MgO)(001) single crystal substrate 100, and then, a BST thin film 001 is formed by means of pulsed laser ablation method. After that, metallic electrodes 120 and 130 may be formed on the BST thin film 001. The metallic electrodes 120 and 130 are not confined specifically, and may be composed of various kinds of a single metallic film, for example, a gold (Au), a silver (Ag), and etc. Otherwise, they may be composed of a multi-layer electrode metal such as Au/Cr, Au/Ti, Ag/Cr, Ag/Ti, and etc., which is formed by depositing a thin adhesion layer first such as a chrome (Cr), a titanium (Ti), or the like, and then forming the electrode metal such as Au, Ag, or the like with a thickness of about three times thicker than a skin depth of microwave. In the case of the multi-layer electrode metal, it may be formed with a thickness of about 2 μm.

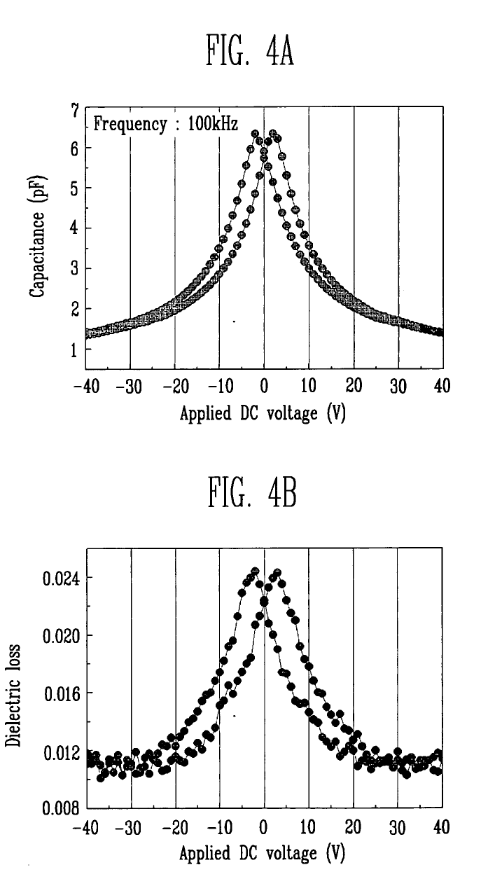

FIGS. 4A and 4B are graphs showing variations of electric capacitance and dielectric loss depending on a variation of a voltage applied to the voltage control variable capacitor of FIG. 3.

If the DC voltage is applied to the electrodes 120 and 130 disposed in upper both edges of the voltage-controlled tunable capacitor, dielectric permittivity and dielectric loss of the BST thin film become changed, so that electric capacitance of the voltage-controlled tunable capacitor comes to be changed. Therefore, microwave frequency/phase become changed in the case of implanting the tunable filter or the phase shifter device using the tunable capacitor.

Referring to FIGS. 4A and 4B, the tunability [{C(0 V)−C(40 V)}/C(0 V)] of electric capacitance (or dielectric permittivity) could be obtained 78% or more and the dielectric loss is in the range of 0.022 to 0.001, in the case of applying the DC bias voltage in the range of 0 to 40 V. Accordingly, it could be assumed that the reason for showing improved dielectric properties as mentioned above is that crystalinity of the BST thin film is improved by applying the thin ferroelectric BT seed layer on the substrate, and the strain/stress effect caused by the lattice mismatching with the substrate inside the BST thin film is decreased.

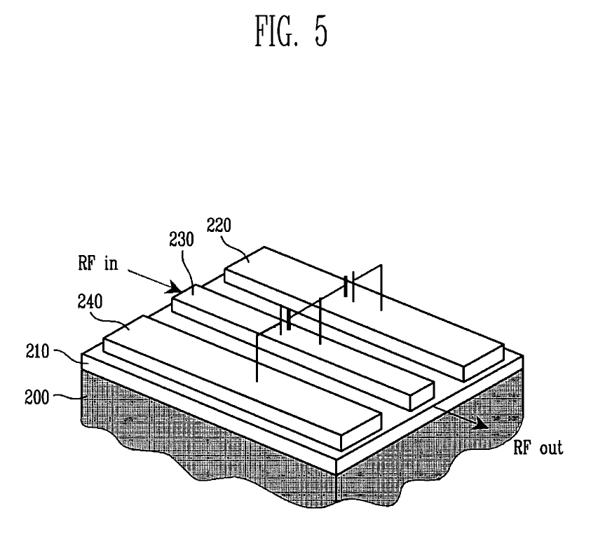

FIG. 5 is a perspective view of a coplanar waveguide phase shifter that is one of the microwave tunable devices according to the present invention. The coplanar waveguide phase shifter of the present invention comprises a BST/BT film 210 on a substrate 200 and metallic electrodes 220, 230, and 240 formed thereon.

The coplanar waveguide phase shifter is a core device that enables switching and scanning/steering of microwave electronic beam, by being connected to a radiator of a phased array antenna. By employing the coplanar waveguide phase shifter of the present invention, it is possible to realize ultra high speed, low electric power, low cost, small size, and high performance electronic scanning, and thus, to reduce size, weight, and cost in the phased array antenna. In addition, it is possible to implant the ultra high speed ferroelectric electronic scan phased array antenna that the phase of the antenna beam can be controlled by only using a voltage amplifier and a fine controller, in which there is no necessity for a mechanical/physical rotation of the antenna.

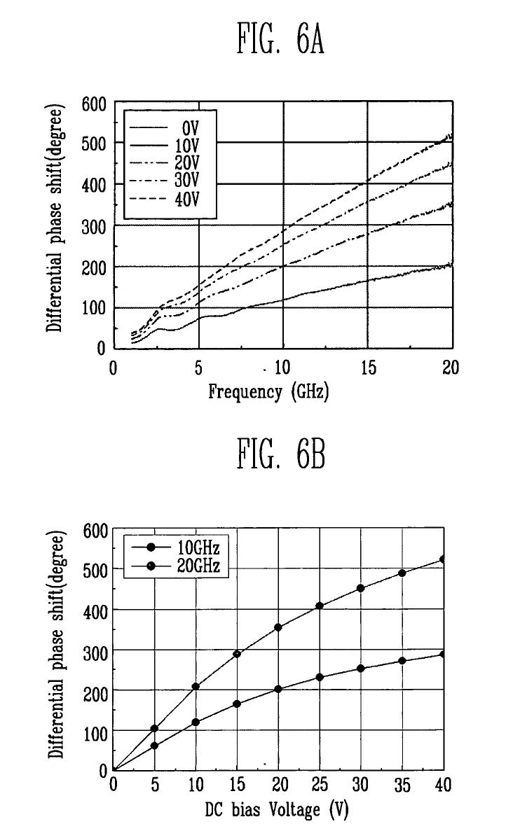

FIGS. 6A and 6B are graphs showing differential phase shift property depending on a frequency and an applied DC bias voltage of the coplanar waveguide phase shifter of FIG. 5.

Referring to FIGS. 6A and 6B, the differential phase shift corresponds to a difference of the phases at 0 V and 40 V, and it relates to the tunability of dielectric permittivity of the BST thin film. Thus, if the tunability of dielectric permittivity is large, the differential phase shift becomes large. Generally, it is required a large value of about 360 degrees in the differential phase shift, even though it depends on practical uses, when being applied to a system such as the phased array antenna.

In the device fabricated by using the BST(001)/BT(001)/MgO(001) multi-layer epitaxial thin film, the differential phase shift, insertion loss, and reflection loss are 287 degrees, −7 dB or more, and −15 dB or less, respectively, under the conditions of 10 GHz and 40 V in an applied DC bias voltage. In addition, the differential phase shift, insertion loss, and reflection loss at 20 GHz are 521 degrees, −12 dB or more, and −14 dB or less, respectively.

Therefore, it is expected that the reason for showing improved properties as mentioned above is that crystalinity of the BST thin film is improved by forming the BST thin film on the BT seed layer and the tunability of dielectric permittivity is improved due to a decrease of the strain/stress effect inside the BST thin film.

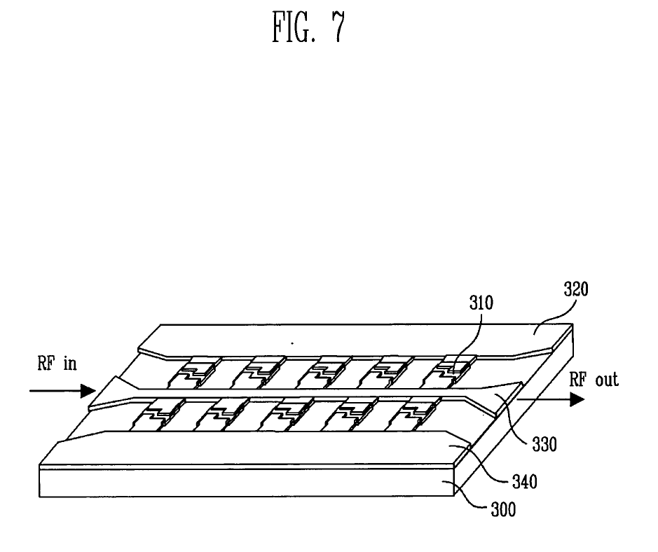

FIG. 7 is a perspective view of a loaded line type ferroelectric phase shifter that is to one of the microwave tunable devices according to the present invention. The phase shifter of the present invention comprises a BST/BT thin film 310 patterned on a substrate 300 and metallic electrodes 320, 330, and 340 formed thereon.

The phase shifter has a BST/BT voltage-controlled tunable capacitor using the BST(001)/BT(001)/MgO(001) multi-layer epitaxial thin film, which is periodically connected to the coplanar waveguide (CPW) phase shifter having high impedance, and it lowers an operation applied voltage of the ferroelectric phase shifter while keeping the circuit property constant, by controlling a gap between fingers of the voltage-controlled tunable capacitor, and thus, making the electric field strength equal in the ferroelectric thin film.

In addition, it is possible to improve accuracy of the design, and thus, to reduce insertion loss and reflection loss of the device, by implanting the voltage-controlled tunable capacitor through an etching process of the ferroelectric BST thin film, in order to prevent undesirable variation of the characteristic in the CPW phase shifter and reduce dielectric loss of the BST thin film.

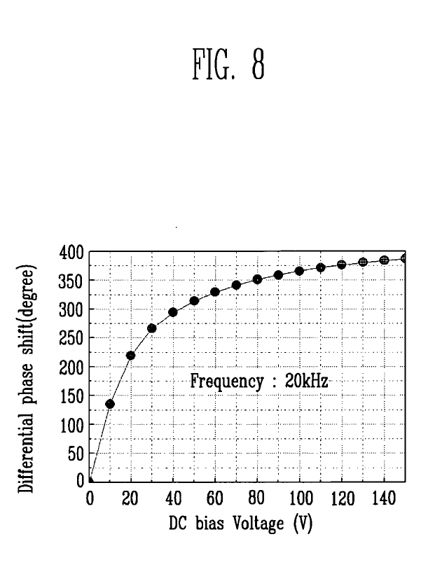

FIG. 8 is a graph showing differential phase shift depending on an applied DC bias voltage of the loaded line type ferroelectric phase shifter, which is implanted using the BST(001)/BT(001)/MgO multi-layer epitaxial thin film. The differential phase shift, insertion loss, and reflection loss, at 20 GHz and 40 V of an applied DC bias voltage, are 294 degrees, −5.6 dB or more, and −16 dB or less, respectively. And, the differential phase shift is 387 degrees, in the case of applying DC bias voltage up to 150 V.

Thus, it can be noted that the voltage-controlled ferroelectric microwave tunable device having improved microwave characteristics could be realized by using the BST(001)/BT(001)/MgO multi-layer epitaxial thin film with improved dielectric properties, as described above.

Meanwhile, the tunability and dielectric loss of the ferroelectric BST thin film grown on the oxide single crystal may be affected by a number of factors such as oxygen vacancies, thickness of the thin film, grain size, doping element, Ba/Sr composition ratio, strain/stress inside the thin film, crystalinity of the thin film, and so on.

According to the present invention as described above, it is possible to improve the microwave response property of the microwave tunable device by using the ferroelectric epitaxial thin film, which has a large dielectric permittivity and a low dielectric loss according to an external applied voltage. By using the device of the present invention as an active phased array antenna system, a satellite communication system, or a wireless sensor system, the quality of the wireless communication could be improved with ultra high speed, low electric power, low cost, and high sensitivity.

Particularity, it is possible to implant an electronic scanning with ultra high speed, which enables a next generation mobile wireless multimedia service, and a ferroelectric electronic scan phased array antenna capable of multiple-target tracking, by employing the voltage-controlled ferroelectric phase shifter with ultra high speed, low electric power, and low cost.

Although the present invention have been described in detail with reference to preferred embodiments thereof, it is not limited to the above embodiments, and several modifications thereof may be made by those skilled in the art without departing from the technical spirit of the present invention. In the preferred embodiment of the present invention, as described above, the voltage-controlled tunable capacitor, a CPW phase shifter, a loaded line type phase shifter were explained as an example. However, the present invention is not confined thereto, and could be applied to all microwave tunable devices using the ferroelectric thin film without the limitation of the structure thereof.

The present application contains subject matter related to korean patent application no. 2003-89374, filed in the Korean Patent Office on Dec. 10, 2003, the entire contents of which being incorporated herein by reference.

1. A ferroelectric epitaxial thin film for a microwave tunable device, comprising:
a ferroelectric BaTiO₃ seed layer formed on a substrate with a predetermined thickness; and
an epitaxial (Ba₁₋ₓSrₓ)TiO₃ (hereinafter, referred as to BST) thin film formed on the BaTiO₃ seed layer.

2. The ferroelectric epitaxial thin film as claimed in claim 1, wherein the substrate is a magnesium oxide (MgO) single crystal substrate.

3. The ferroelectric epitaxial thin film as claimed in claim 1, wherein the epitaxial BST thin film has a composition of (Ba₁₋ₓSrₓ)TiO₃, where x is in the range of 0.1 to 0.9.

4. The ferroelectric epitaxial thin film as claimed in claim 1, wherein the BaTiO₃ seed layer and/or the (Ba₁₋ₓSrₓ)TiO₃ film is an epitaxial thin film grown by means of pulse laser ablation, radio frequency (RF) magnetron sputtering, chemical vapor deposition, or atomic layer deposition method.

5. The ferroelectric epitaxial thin film as claimed in claim 1, wherein the microwave tunable device is a voltage-controlled tunable capacitor, a tunable resonator, a tunable filter, a phase shifter, a voltage-controlled tunable oscillator, a duplexer, or a divider.

6. The ferroelectric epitaxial thin film as claimed in claim 1, wherein the BaTiO₃ seed layer has a thickness in the range of several Å to hundreds of Å, and the BST thin film has a thickness in the range of 0.1 μl to 1 μm.

7. A microwave tunable device, comprising:
a substrate;
a ferroelectric epitaxial thin film for the microwave tunable device formed on the substrate; and
at least one of electrodes formed on the ferroelectric epitaxial thin film, wherein the ferroelectric epitaxial thin film, comprising a ferroelectric BaTiO₃ seed layer formed on the substrate with a predetermined thickness, and an epitaxial (Ba₁₋ₓSrₓ)TiO₃ (BST) thin film formed on the BaTiO₃ seed layer.

8. The microwave tunable device as claimed in claim 7, wherein the substrate is a magnesium oxide (MgO) single crystal substrate.

9. The microwave tunable device as claimed in claim 7, wherein the epitaxial BST thin film has a composition of (Ba₁₋ₓSrₓ)TiO₃, where x is in the range of 0.1 to 0.9.

10. The microwave tunable device as claimed in claim 7, wherein the BaTiO₃ seed layer and/or the (Ba₁₋ₓSrₓ)TiO₃ film is an epitaxial thin film grown by means of pulse laser ablation, radio frequency (RF) magnetron sputtering, chemical vapor deposition, or atomic layer deposition method.

11. The microwave tunable device as claimed in claim 7, wherein the microwave tunable device is a voltage-controlled tunable capacitor, a tunable resonator, a tunable filter, a phase shifter, a voltage-controlled tunable oscillator, a duplexer, or a divider.

12. The microwave tunable device as claimed in claim 7, wherein the BaTiO₃ seed layer has a thickness in the range of several A to hundreds of A, and the BST thin film has a thickness in the range of 0.1 μm to 1 μm.

13. The microwave tunable device as claimed in claim 7, wherein the microwave tunable device is a frequency or a phase tunable device.

14. The microwave tunable device as claimed in claim 13, wherein the microwave tunable device is a voltage-controlled tunable capacitor, a phase shifter such as a coplanar waveguide phase shifter and a loaded line type phase shifter, a tunable resonator, a tunable filter, a voltage-controlled tunable oscillator, a duplexer, or a divider.

15. The microwave tunable device as claimed in claim 7, wherein the electrodes are composed of a multi-layer metallic film including a single metal layer or an adhesion layer.

16. The microwave tunable device as claimed in claim 15, wherein the multi-layer metallic film is Au/Cr, Au/Ti, Ag/Cr, or Ag/Ti.
